(19) United States
(12) Patent Application Publication
(10) Pub. No.: US 2005/0175039 A1
(43) Pub. Date: Aug. 11, 2005

(54) Radio-controlled clock and method for determining the signal quality of a transmitted time signal

(76) Inventors: Horst Haefner, Heilbronn (DE); Roland Polonio, Neckarsulm (DE); Hans-Joachim Sailer, Heilbronn (DE)

Correspondence Address: FASSE PATENT ATTORNEYS, P.A., P.O. BOX 726, HAMPDEN, ME, 04444-0726, US

(21) Appl. No.: 11/046,225

(22) Filed: Jan. 28, 2005

(30) Foreign Application Priority Data
Jan. 29, 2004 (DE) 10 2004 004 416.3

(51) Int. Cl. H04Q 11/00

(52) U.S. Cl. 370/503

(57) ABSTRACT

A transmitted time signal carries time information encoded bit-wise by signal variations in a succession of constant duration time frames, with at least one bit in each time frame. A signal quality is determined and allocated to a respective bit, e.g. depending on the extent of deviation of an actual duration from prescribed durations of a signal variation representing the bit. Thus, a respective signal quality may be allocated to a respective decoded data bit per time frame. Successive data bits can be categorized as interference-free or interference-burdened, and a signal quality of the received time signal can alternatively be determined from the number or ratio of the interference-free bits and the interference-burdened bits. A radio-controlled clock circuit includes a receiving circuit, a bit value decoding arrangement and a signal quality evaluating arrangement.

### PRIORITY CLAIM

This application is based on and claims the priority under 35 U.S.C. §119 of German Patent Application 10 2004 004 416.3, filed on Jan. 29, 2004, the entire disclosure of which is incorporated herein by reference.

### FIELD OF THE INVENTION

The invention relates to methods for determining the signal quality of a time signal transmitted by a time signal transmitter. The invention further relates to a receiver circuit and/or a radio-controlled clock for carrying out such a method.

### BACKGROUND INFORMATION

It is conventionally known to provide time reference information in time signals that are transmitted by radio transmission from a time signal transmitter. Such a signal may also be called a time marker signal, a time data signal, a time code signal, or a time reference signal, for example, but will simply be called a time signal herein for simplicity. The time signal transmitter obtains the time reference information, for example, from a high precision atomic clock, and broadcasts this highly precise time reference information via the time signal. Thus, any radio-controlled clock receiving the signal can be synchronized or corrected to display the precise time in conformance with the time standard established by the atomic clock that provides the time reference information for the time signal transmitter. The time signal is especially a transmitter signal of short duration, that serves to transmit or broadcast the time reference information provided by the atomic clock or other suitable time reference emitter. In this regard, the time signal is a modulated oscillation generally including plural successive time markers, which each simply represent a pulse when demodulated, whereby these successive time markers represent or reproduce the transmitted time reference with a given uncertainty.

A time signal transmitter as mentioned above is, for example, represented by the official German longwave transmitting station DCF-77, which continuously transmits amplitude-modulated longwave time signals controlled by atomic clocks to provide the official atomic time scale for Central European Time (CET), with a transmitting power of 50 kW at a frequency of 77.5 kHz. In other countries, such as Great Britain, Japan, China, and the United States, for example, similar transmitters transmit time information on carrier waves in a longwave frequency range from 40 kHz to 120 kHz. In all of the above mentioned countries, the time information is transmitted in the time signal by means of a succession of time frames organized in time code telegrams that each have a duration of exactly one minute.

FIG. 1 diagrammatically represents the coding scheme of a time code or time information telegram A that pertains for the encoded time information provided by the German time signal transmitter DCF-77. The coding scheme or telegram in this case consists of 59 bits in 59 time frames, whereby each single bit or time frame corresponds to one second. Thus, the so-called time code telegram A, which especially provides information regarding the correct time and date in binary encoded form, can be transmitted in the course of one minute. The first 15 bits in bit range B comprise a general encoding, which contain operating information, for example. The next 5 bits in bit range C contain general information. Particularly, the general information bits C include an antenna bit R, an announcement bit A1 announcing or indicating the transition from Central European Time (CET) to Central European Summer Time (CEST) and back again, zone time bits Z1 and Z2, an announcement bit A2 announcing or indicating a so-called leap second, and a start bit S of the encoded time information.

From the 21^{st} bit to the 59^{th} bit, the time and date informations are transmitted in a Binary Coded Decimal (BCD) code, whereby the respective data are pertinent for the next subsequent or following minute. In this regard, the bits in the range D contain information regarding the minute, the bits in the range E contain information regarding the hour, the bits in the range F contain information regarding the calendar day or date, the bits in the range G contain information regarding the day of the week, the bits in the range H contain information regarding the calendar month, and the bits in the range I contain information regarding the calendar year. These informations are present bit-by-bit in encoded form. Furthermore, so-called test or check bits P1, P2, P3 are additionally provided respectively at the ends of the bit ranges D, E and I. The 60^{th} bit or time frame of the time code telegram A is not occupied, i.e. is “blank” and serves to indicate the beginning of the next telegram A. Namely, the minute marker M following the blank interval represents the beginning of the next time code telegram A.

The structure and the bit occupancy of the encoding scheme or telegram A shown in FIG. 1 for the transmission of time signals is generally known, and is described, for example, in an article by Peter Hetzel entitled “Zeitinformation und Normalfrequenz” (“Time Information and Normal Frequency”), published in Telekom Praxis, Vol. 1, 1993.

The transmission of the time marker or code information is performed by amplitude modulating a carrier frequency with the individual second markers. More particularly, the modulation comprises a dip or lowering or reduction X1, X2 (or alternatively an increase or raising) of the carrier signal X at the beginning of each second, except for the 59^{th} second of each minute, when the signal is omitted or blank as mentioned above. In this regard, in the case of the time signal transmitted by the German transmitter DCF-77, the carrier amplitude of the signal is reduced, to about 25% of the normal amplitude, at the beginning of each second for a duration X1 of 0.1 seconds or for a duration X2 of 0.2 seconds, for example as shown in present FIG. 2.

These amplitude reductions or dips X1, X2 of differing duration respectively define second markers or data bits in decoded form. The differing time durations of the second markers serve for the binary encoding of the time of day and the date, whereby the second markers X1 with a duration of 0.1 seconds correspond to the binary “0” and the second markers X2 with the duration of 0.2 seconds correspond to the binary “1”. Thus the modulation represents a binary pulse duration modulation. As mentioned above, the absence of the 60^{th} second marker announces the next following minute marker.

Thus, in combination with the respective second, it is then possible to evaluate the time information transmitted by the time signal transmitter. FIG. 2 shows a portion of an example of such an amplitude modulated time signal as discussed above, in which the encoding is achieved by respective temporary reductions or dips of the amplitude having different pulse durations. Note that the total duration of each time frame from the beginning of one dip to the beginning of the next dip or second marker X1 or X2 amounts to 1000 msec or 1 second, while the individual dips or amplitude reductions acting as second markers X1 and X2 respectively have individual durations of 100 msec or 200 msec, i.e. 0.1 seconds or 0.2 seconds, as described above for the German transmitter DCF-77.

This evaluation of the exact time and the exact date is, however, only possible if the fifty-nine second bits of a minute are unambiguously recognized, and thus correspondingly, it is possible to unambiguously allocate either a “0” or a “1” to each of the second markers represented by the second bits of the signal. In this regard it is problematic that the received time signals can be obscured or falsified by interference signals superimposed thereon. Such interference signals arise from the interference fields emitted by electrical or electronic devices, for example in the direct surrounding vicinity of the time signal receiver. Depending on the type, scope and strength of these interference signals, the reception of the time signal will be more or less interfered with, and it may become impossible to correctly recognize and evaluate the second markers of the signal. In this context, the concept of the signal being disturbed or interference-burdened, i.e. superimposed with interference and thereby garbled or falsified, means that one or more binary value allocation errors have been made in the evaluation of the received minute protocol, i.e. the complete time telegram of a respective minute. Through such erroneous evaluation decisions, due to the interference, at least one of the data bits of the minute protocol is erroneously decoded or not decoded at all.

The general technical background of radio-controlled clocks and receiver circuits for receiving, time signals as generally discussed above are disclosed in the German Patent Publications DE 198 08 431 A1, DE 43 19 946 A1, DE 43 04 321 C2, DE 42 37 112 A1, and DE 42 33 126 A1. Furthermore, the methods and techniques for acquiring and processing the time information from transmitted time signals are disclosed in Patent Publications DE 195 14 031 C2, DE 37 33 965 C2, and EP 0,042,913 B1. A method for determining the beginning of a second is described in the German Patent Publication DE 195 14 036 C2.

In a receiver of a radio-controlled clock, it is conventionally known to provide indicators for quantifying and qualifying the reception conditions and therewith the interference in the transmitted time signal. For example, the European Patent Publication EP 0,455,183 A2 discloses using, for example, the received field strength as an indicator in this regard. Particularly, the radio-controlled clock indicates how high the received field strength of the received signal is, at a particular installed or set-up position of the radio-controlled clock. In this manner, by checking the indicated received field strength, the user of the clock can very easily move the clock as necessary to different locations in a search for a higher received field strength. Thus, such time signal receivers provide a signal by which the received field strength can be considered or evaluated, which makes it possible for the user to manually re-orient the receiving antenna into the best direction for achieving the maximum received field strength, or to re-position the radio-controlled clock to such a location at which the field strength is maximized.

A problem or shortcoming of the above conventional system and method is that the field strength indication does not provide any direct information about interference to the user, i.e. whether the time signal telegram of the time signal itself has been received without interference. Instead, the user merely receives an indication that a certain received field strength exists at a certain selected location of the clock and/or a certain selected orientation of the receiving antenna. However, that received field strength could actually also include interference in the received signal. Thus, the above mentioned conventional method and system are not suitable for evaluating the actual signal quality of the received time signal, especially in situations in which the field strength of an interference signal quantitatively lies within the range of the field strength of the useful time signal.

In view of the above, the conventionally known methods for evaluating the signal reception only enable an indirect evaluation of a presumed or perceived signal quality on the basis of the field strength of the received time signal, which may, however, include a superimposed interference signal. Thus, the provided field strength information does not give an accurate or valid indication of the true time signal quality in a consistent and reliable manner.

At the present time, there is no conventionally known method and no conventionally known arrangement for evaluating the signal quality of a time signal received by a radio-controlled clock, whereby the signal quality evaluation is based on parameters of the recognized and decoded data bits contained in the time signal. Such an evaluation would give a true indication of the signal quality of the received useful signal, but the prior art has not developed any solutions in this direction.

### SUMMARY OF THE INVENTION

In view of the above, it is an object of the invention to provide, in a method and a circuit arrangement, an indicator regarding the signal quality of a time signal that has been transmitted by a time signal transmitter and received by a time signal receiver, such as in a radio-controlled clock. Another object of the invention is to evaluate the signal quality based on an evaluation of the amount or degree of interference in the received signal. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a method of processing a transmitted time signal, comprising the steps:
a) receiving a time signal that has been transmitted from a time signal transmitter, wherein the time signal comprises a succession of time frames and encodes time information bit-wise in successive data bits, with at least a respective one of the data bits provided in each one of the time frames;
b) evaluating a respective signal quality of the time signal respectively for at least one of the data bits in each one of the time frames; and
C) based on the evaluating, further determining and allocating respective signal quality values individually to respective ones of the data bits among respective ones of the time frames.

The above objects have further been achieved according to the invention in a method of processing a transmitted time signal, comprising the steps:
a) receiving a time signal that has been transmitted from a time signal transmitter, wherein the time signal comprises a succession of time frames and encodes time information bit-wise in successive data bits, with at least a respective one of the data bits provided in each one of the time frames;
b) respectively determining whether each one of a plurality of the data bits is an interference-free data bit that was received without significant interference in the step a) or an interference-burdened data bit that was received with significant interference in the step a); and
c) determining a signal quality of the time signal received in the step a) from and dependent on a first number of the interference-free data bits determined in the step b) and a second number of the interference-burdened data bits determined in the step b).

Still further, the above objects have also been achieved according to the invention in a circuit arrangement for receiving and acquiring time information from a time signal that is transmitted by a time signal transmitter and that has the time information encoded in successive data bits in successive time frames therein, the circuit arrangement comprising: a receiver adapted to receive the time signal; a decoder connected to an output of the receiver and adapted to decode the time signal to acquire and decode the data bits therefrom; and a signal quality evaluation arrangement connected to the receiver and to the decoder and adapted to determine and allocate a respective signal quality of the time signal received by the receiver respectively for each data bit decoded by the decoder per each one of the time frames.

According to the invention, for determining the signal quality of the received time signal, the durations of the respective second markers of the received time signal are determined and evaluated. In this regard, the present invention makes use of the known (nominal or ideal) pulse durations of the respective second markers that are prescribed by the particular telegram or encoding scheme of a given received time signal. Thereby, a given data bit representing a particular second is evaluated as a (substantially) interference-free received data bit, if the actual duration of the second marker corresponding to this data bit does not deviate or only deviates slightly from a respective one of the prescribed durations for the respective second markers as known from the pertinent time signal telegram or encoding scheme of the received time signal.

A data bit that exhibits no deviation or only slight deviation of its actual duration relative to the corresponding prescribed duration is thus allocated a high signal quality. This is the case if the received time signal was not, or only slightly, burdened by a superimposed interference signal especially during the duration of the respective second marker at issue, so that an interference-free reception and therewith an unambiguous decoding of the respective data bit was possible.

On the other hand, it is also possible for the case to arise, that a received time signal is so strongly burdened by interference, and thereby falsified or garbled, especially during the duration of a respective second marker of interest, that it becomes impossible or very difficult to carry out an unambiguous evaluation and decoding of the second marker, i.e. an unambiguous allocation of a binary data bit to the respective second marker. In this regard, the data bit is considered a “no longer interference-free received” data bit, in other words a disturbed, interference-burdened, falsified or garbled data bit.

The basic underlying idea of a first aspect of the present invention involves respectively allocating a respective signal quality to at least one data bit per time frame of a received time signal (to the extent that a valid signal quality can be determined for each given bit). In this regard, it should be understood that it is not mandatory to allocate a signal quality to every single data bit of the received time signal. For example, as explained further below, a determination or allocation of a signal quality for a particular bit may be omitted, and the decoding of such a bit may be omitted, for example if the respective bit suffers severe interference. In any event, the inventive method involving an allocation of a respective signal quality to individual data bits of the received time signal provides an indication or information regarding how surely or reliably the data information contained in the respective data bit was acquired, for consideration in the further evaluation of the various data bits. This achieves a higher flexibility as well as a higher security and reliability in the evaluation of the time information contained in the received time signal.

Through the inventive manner of the evaluation of the individual decoded second markers, or especially from the comparison of the evaluation of several second markers of received time signals, the inventive method acquires a dependable or reliable information regarding the condition of the received signal. From that information, further steps may be taken, if desired, involving targeted measures for improving the signal reception, for example by re-locating the radio-controlled clock receiver, or by re-orienting the orientable receiving antenna, or the like.

Thus, the received field strength is no longer, or no longer exclusively, used as a measure for the actual signal quality of the received time signal. Instead, the inventive method uses the corresponding encoding of the received time information itself to determine or evaluate the signal quality. Especially in reception situations with a relatively low field strength, the inventive manner of signal evaluation and judgment achieves a considerable advantage over conventional methods of judging the signal quality solely from the received field strength.

According to the particular encoding scheme represented in the particular time signal telegram of the particular time signal transmitter of which the signal is being received, a value of a respective data bit will be given by the respective duration of a change or variation of the amplitude of the transmitted time signal. Then, a binary data value is allocated to each respective data bit in response to and dependent on the duration of this variation of the amplitude representing the particular second marker or data bit. In this regard, a first nominal or prescribed duration of the amplitude variation of the time signal represents a first logic value of a respective data bit, while a second nominal or prescribed duration similarly represents a second logic value of a respective data bit. The first and second nominal durations are specified by the particular encoding scheme or telegram of the time signal transmitter at issue. It is also possible that third or further distinct durations of time signal amplitude variations are present in the time signal, for example according to the telegrams of the United States time signal transmitter WWVB and the Japanese time signal transmitter JJY.

According to the invention, a signal quality is determined depending on the deviation of the actual duration of an amplitude variation measured in the received time signal, relative to the first or second prescribed duration. Typically, a higher signal quality is allocated to a respective decoded data bit, the smaller the deviation between the actual measured duration and the first or second prescribed duration. It can additionally be provided that different signal qualities are assigned for the same deviation but with respect to the first prescribed duration or the second prescribed duration. This is suitable, for example, in a case in which the respective data bit can still be surely and reliably recognized even if there is a relatively large deviation of the actual measured duration from the prescribed duration with respect to an amplitude variation in the range of the first prescribed duration, while it becomes difficult to evaluate and unambiguously recognize a respective data bit already for a relatively small deviation of the actual duration of an amplitude variation in the range of the second prescribed duration. This is especially advantageous when switching between various different national time signal encoding protocols.

In a first particular embodiment or feature of the inventive method, first deviations of the actual duration relative to the first or second prescribed duration define a first interval, while second deviations of the actual duration relative to the first or second prescribed durations define a second interval, whereby the first deviations are respectively smaller in magnitude than the second deviations. In this case, a large or high signal quality is allocated to a respective data bit having a deviation (of actual duration from prescribed duration) falling in the first interval, while a lower signal quality is allocated to a respective data bit having a deviation (of actual duration from prescribed duration) falling in the range of the second interval.

In a further development of the inventive method, third deviations of the actual duration relative to the first or second prescribed duration define a third interval, whereby these third deviations have magnitudes respectively larger than the second deviations defining the second interval. In this case, an even lower signal quality, i.e. lower than the signal quality associated with the second interval, is allocated to a respective data bit exhibiting a duration deviation falling into the third interval.

In still a further alternative or additional development of the invention, fourth deviations of the actual duration relative to the first or second prescribed duration define a fourth interval, whereby the fourth deviations have magnitudes that are respectively greater than the third or second deviations. In this case, a respective data bit having a duration deviation falling into the fourth interval will not even have a signal quality allocated to it. In other words, in such a situation, the deviation of the actual measured duration of a second marker in the time signal corresponding to this respective data bit, relative to the first or second prescribed duration of a valid data bit, is so large that one must conclude that there has been a high degree of interference that prohibits an unambiguous and reliable decoding of this data bit. Thus, an assignment of a signal quality to this data bit is suppressed or otherwise omitted. Additionally or alternatively it can be provided that the assignment of a signal quality to the respective data bit is already suppressed or omitted when the pertinent deviation of this data bit falls into the-third interval mentioned above.

Another feature of the inventive method provides that a decoding of a respective data bit, and therewith an allocation of a logic value to the respective time frame containing this data bit, is suppressed or omitted if the respective data bit exhibits a deviation (of its actual time duration relative to the first or second prescribed time duration) in the range of the third or fourth intervals. In these third and fourth intervals, the time signal is, for example, so strongly superimposed by interference, that no defined amplitude variation can be recognized, and thus an unambiguous decoding thereof is not possible.

As soon as a signal quality has been determined and allocated to a respective time frame, i.e. to a respective data bit of this time frame, then this signal quality or a corresponding information derived therefrom is typically displayed or otherwise indicated, or output in some other manner. Advantageously, the respective determined signal quality can be indicated or output for each individual time frame or for each individual data bit.

In a particularly advantageous further development of the invention, the value of the signal quality is determined by incrementing and/or decrementing a counter provided for this purpose. This counter comprises a respective different counter adjustment (or incrementing or decrementing) value for the various different intervals and thus for different deviations of the actual duration relative to the first or second prescribed durations. In that regard, the counter value represents a measure for the determined deviation of the actual duration from the first or second prescribed duration, and thus represents a measure for the signal quality.

In an especially advantageous embodiment of the invention, an overall or total signal quality is obtained through averaging or mean value formation of the determined signal qualities of plural individual time frames. In this manner, it is possible to obtain additional information over the course of several successive time frames, which indicates how the signal quality changes or progresses over a longer time span. This averaged or overall signal quality can be indicated or outputted in addition to, or separately from, the basic or individual signal quality values discussed above.

An especially advantageous embodiment of the inventive method provides that a monitoring and testing of the received signal in comparison to plural stored national protocol parameters is carried out, if no signal quality was determined for at least one, but advantageously several successive time frames. Such a monitoring and evaluation can be called or regarded as a scan with respect to the available stored national protocol parameters. The failure to determine a signal quality may, for example, arise if the time signal telegram information stored in a memory and being used for the evaluation is no longer current, i.e. is no longer applicable to the particular time signal currently being received. For example, this may be the case if the radio-controlled clock or other time signal receiver is now operating in a different country or different region in which the currently stored telegram information no longer applies. Thus, by carrying out such a scan, the method aims to determine which particular time signal transmitter has transmitted the time signal presently being received. Typically, this involves a country-specific scan in order to determine which country-specific time signal is currently being received. According to a further feature of the invention, such a scan can also be carried out if the determined signal quality lies below a prescribed threshold value, i.e. if the signal quality is very low or very poor, for example.

Typically, the first logic value refers to a logic “0” (low signal or low voltage level) and the second logic value represents a logic “1” (high signal or high voltage level). Of course, the opposite logic allocation is also possible.

In most existing encoding schemes, i.e. time signal telegrams, of a respective time signal transmitted by various official time signal transmitters, a change or variation of the signal refers particularly to a temporary decrease or dip of the amplitude of the carrier signal of the time signal. Of course, the opposite type of variation is also possible within the scope of the invention, namely that the variation of the signal carrying out the binary encoding involves a temporary increase of the amplitude rather than a temporary decrease thereof.

Typically according to the invention, before determining the signal quality, the respective actual durations of the individual second markers of the received time signal are determined and evaluated for acquiring the respective corresponding data bits. Within the scope of the invention, the decoding and evaluation of the data bits can be carried out before and/or after the determination and allocation of the signal quality to each respective data bit.

In a particular embodiment of the inventive method, the duration of a respective change or variation of the amplitude of the received signal is measured or determined by counting the clock or timing pulses of a reference clocking signal, i.e. timing pulse signal having a known or prescribed reference frequency. In this regard, the invention especially makes use of a reference pulse generator, which generates a reference pulse clocking signal or timing pulse signal with a prescribed constant pulse or clocking frequency. For the further determination of the duration of an amplitude change of the signal, and thus for specifically fixing and allocating the signal quality of a given data bit, it is simply necessary to additionally know the beginning and the end of a given change or variation of the signal amplitude. From the difference between the thusly determined time points of the beginning and the end of a detected temporary variation, e.g. decrease or dip, of the signal amplitude, thereby the actual duration of the variation can be determined, and this actual duration is then compared to the available prescribed duration to determine the respective deviation. However, such an end and/or beginning of a detected temporary amplitude variation may actually represent or fall within a superimposed interference within the range of the first or the second prescribed duration corresponding to the first and second logic values. Such an interference (among other things) thus causes the deviation of the actual duration from the ideal prescribed durations.

In a further advantageous embodiment of the invention, not only the extent of the deviation of the time duration (as discussed above), but also the received field strength are used together for determining the signal quality of a respective data bit. Additionally or alternatively, further parameters can be used in the determination of the signal quality, for example information indicating which time signal transmitter transmitted the received signal. This is useful information, because experience shows that the time signals transmitted by different time signal transmitters are typically also subject or sensitive to interference in different degrees. A further example of a parameter that can be considered in the determination of the signal quality is the magnitude of the signal variation, i.e. the absolute value of the amplitude variation of the received signal representing a particular data bit.

Typical prescribed durations of a signal variation, i.e. amplitude variation, representing the second markers and thus the data bits of a time signal amount to 100, 200, 300, 400, 500 and/or 800 msec. These prescribed time durations will also be measured and recognized as actual time durations if the time signal is received without interference. More particularly, the German time signal transmitter DCF-77 includes second markers having prescribed durations of 100 msec and 200 msec, the British time signal transmitter MSF has second markers with respective prescribed durations of 100, 200, 300 and 500 msec, while the United States time signal transmitter WWVB and the Japanese time signal transmitter JJY each use second markers having prescribed durations of 200, 500 and 800 msec.

The invention further provides a second method that represents a further development of the above described first method. The second method is based on the general idea of acquiring or obtaining information about the signal quality of the received time signal from the number of second markers or data bits received without interference and the number of second markers or data bits received with interference. These two categories of second markers can be regarded as interference-free second markers and not-interference-free or interference-burdened second markers, respectively.

In this inventive method, the received time signals may first be decoded. Thereafter, in connection with the decoded data bits, it is determined whether the respective data bit is an interference-free data bit or a not-interference-free data bit (interference-burdened data bit). The signal quality (which can be called a second signal quality to distinguish it from the first signal quality determined according to the first method discussed above) is then determined from a prescribed number of the thusly evaluated data bits. For example, the ratio of interference-free data bits relative to interference-burdened data bits within a certain number of received data bits is used to determine the second signal quality. Then, a signal quality value is derived from the thusly determined second signal quality, and this is indicated or outputted as a measure for the signal quality of the received time signal.

For determining the second signal quality, the respective durations of the second markers of the received time signal are determined and evaluated. In that regard, a particular data bit is valued as an interference-burdened data bit, insofar as the actual measured duration of the second marker corresponding to this data bit deviates unacceptably from the first prescribed duration and the second prescribed duration of valid data bits according to the pertinent encoding protocol or time signal telegram. In this regard, it is sensible to specify a threshold value of a degree of acceptable deviation, because various deviations are to be expected in the actual measured duration, for example already due to limitations of precision and accuracy of the measurements, and due to fluctuations typically existing in any system in connection with the generation and transmission of the time signals as well as the measurement of the received time signals.

Thus, the actual durations of second markers will typically be expected to vary from the ideal value, i.e. the first and second prescribed durations, if even only marginally. Advantageously according to the invention in this context, the acceptable threshold of deviation can be defined as a maximum of up to 10%, or preferably a maximum of up to 5% deviation. In other words, a data bit will be valued as an interference-free data bit if the actual measured duration of the amplitude variation corresponding to this data bit deviates by no more than a maximum of up to 10% from the first or second prescribed duration of amplitude variations defined in the encoding protocol or telegram of the respective pertinent time signal. In a very advantageous embodiment, the maximum deviation is set to 5% instead of 10%, as mentioned above. Generally, such a maximum deviation shall be typically used as the maximum acceptable deviation, for which an interference making a sure decoding of a data bit impossible, being superimposed on the time signal, can still be recognized. Thus, the acceptable degree of deviation will depend on the resources being utilized in a particular case, for example the quality and precision of the decoding arrangement, the evaluating arrangement, and the measuring arrangement for the time duration.

In a very advantageous particular embodiment according to the invention, a second signal quality is respectively determined per each minute, e.g. each telegram, of the received time signal, or particularly of at least several second markers in the respective telegram. In a further embodiment, additional second signal qualities are determined by evaluating data bits from further minutes or telegrams of the received time signal. An overall or average signal quality can then be obtained as the mean or average value of several second signal qualities.

The invention further provides a receiver circuit or particularly a radio-controlled clock for obtaining the signal quality information preferably according to at least one embodiment of the inventive method. This circuit arrangement includes a decoding arrangement and a signal quality evaluating arrangement. The decoding arrangement serves to decode and thus acquire the data bits of the corresponding received time signal. Then, the signal quality evaluating arrangement serves to determine and allocate a signal quality to each decoded data bit per time frame.

According to a particular embodiment, the decoding arrangement comprises a first counter that produces a counter value signal as a measure of the duration of a signal variation by counting the clock or timing pulses of a reference clocking signal or timing pulse signal having a known reference frequency. In this regard, the invention typically provides a reference clock signal generator or reference pulse generator that produces a reference clocking signal with a prescribed clocking or timing pulse frequency that is as constant as possible. For example, the reference clock signal generator can comprise a quartz clock oscillator. The first counter is embodied as an incrementing counter or as a decrementing counter.

The signal quality evaluating arrangement comprises a comparing arrangement, e.g. a comparator, which determines a deviation of the actual measured duration relative to the first or second prescribed duration that is defined by the encoding protocol of the particular received time signal. Furthermore, this signal quality evaluating arrangement is embodied and adapted to determine the respective range or interval in which the respective deviation lies, in order to therefrom determine the corresponding signal quality. For example, the comparator carries out a comparison of the actual measured duration to several duration ranges or intervals, e.g. defined and separated from one another by respective duration threshold points. The signal quality evaluating arrangement additionally comprises a second counter that is embodied as an incrementing/decrementing counter. Depending on the range of the deviation as determined in comparison to the intervals as mentioned above, this second counter either counts up or down, i.e. is either incremented or decremented. Thus, the respective existing counter value of this second counter is a measure of an overall or accumulated signal quality of preceding data bits, while a particular adjustment value of incrementing or decrementing this counter represents the signal quality of a particular individual data bit.

The functions of the inventive signal quality evaluating arrangement can be advantageously realized or embodied in a hard-wired logic circuit. For example, such a logic circuit can be incorporated in a Field Programmable Gate Array (FPGA) circuit or a Programmable Logic Device (PLD) circuit. Furthermore, alternatively, the functions of the signal quality evaluating arrangement can be carried out or incorporated in the microcontroller that is typically already included in a radio-controlled clock. The special advantage of the inventive preferred solution using a separate hard-wired logic circuit, is that thereby the signal quality can be determined in a very simple manner, without burdening the microcontroller for this task. Thus, the microcontroller remains fully available for carrying out other tasks, for example for the decoding and evaluation of the time signal, as well as other user-specific tasks.

According to a further feature of the invention, the circuit arrangement additionally includes an output or indicator device, especially a display or a part of a display. The determined signal quality information, or a value derived therefrom, e.g. a percentage value or a discrete numerical value or a bar graph or the like, can be output via such an output device.

In another embodiment or feature of the invention, the circuit arrangement and particularly the radio-controlled clock additionally comprises a position-adjustable receiving antenna that is adapted to receive the transmitted time signal. According to the invention, the receiving antenna is advantageously positioned in such a manner so as to receive the time signal with the optimal signal quality as determined according to the inventive method.

### BRIEF DESCRIPTION OF THE DRAWINGS

In order that the invention may be clearly understood, it will now be described in connection with example embodiments thereof, with reference to the accompanying drawings, wherein:

FIG. 1 schematically represents the encoding scheme of a time code telegram of encoded time information transmitted by the official German time signal transmitter DCF-77, as conventionally known;
FIG. 2 is a time diagram representing a portion of an amplitude modulated time signal having five second pulses or markers, shown schematically in idealized form without interference, as transmitted by the German time signal transmitter DCF-77;

FIG. 3A is a schematic time diagram showing a portion of a time signal corresponding to the time signal telegram of FIGS. 1 and 2;

FIG. 3B is a schematic time diagram representing a time signal corresponding to that of FIG. 3A, as actually received by the time signal receiver, without significant interference, i.e. essentially interference-free;

FIG. 3C is a schematic time diagram representing a time signal corresponding to that of FIG. 3A, as actually received by the time signal receiver, with significant interference, i.e. not-interference-free;

FIG. 4 is a schematic time diagram illustrating the inventive determination of the signal quality of an individual data bit within a time frame; and

FIG. 5 is a schematic block circuit diagram, in drastically simplified form, of a circuit arrangement of a radio-controlled clock for carrying out the method according to the invention.

### DETAILED DESCRIPTION OF PREFERRED EXAMPLE EMBODIMENTS AND OF THE BEST MODE OF THE INVENTION

In all of the drawing figures, the same elements and signals, as well as the elements and signals respectively having the same functions, are identified by the same reference numbers, unless the contrary is indicated.

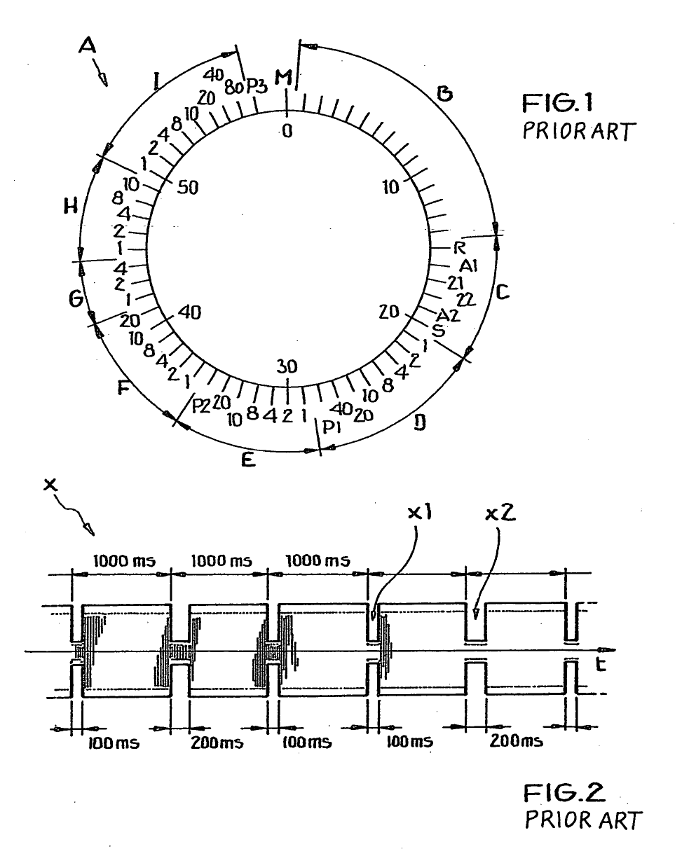

The general format of an encoding scheme or time code telegram A as conventionally known in the time signal transmitted by the German time signal transmitter DCF-77 has been explained above in connection with FIG. 1 in the Background Information section of this specification. Also, the time-variation of the amplitude-modulated time signal is schematically shown in the time diagram of FIG. 2 as discussed above.

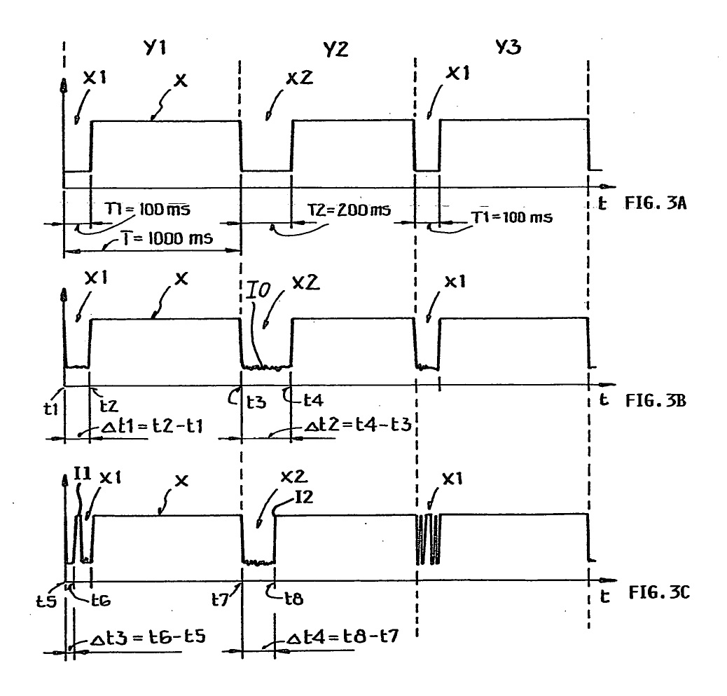

FIG. 3 includes three sub-figures, namely FIGS. 3A, 3B and 3C respectively showing variants of a time signal. FIG. 3A shows a portion of an idealized time signal as transmitted by the German time signal transmitter DCF-77, for example in accordance with the time signal telegram discussed above in connection with FIGS. 1 and 2. FIGS. 3B and 3C respectively show corresponding time signals as received by a time signal receiver in an interference-free condition (FIG. 3LB) and a not-interference-free or interference-burdened condition (FIG. 3C). The inventive method will now be explained in connection with FIG. 3, including the sub-figures FIG. 3A, FIG. 3B, and FIG. 3C.

As an example, FIG. 3A shows a portion of the time signal X transmitted by the German time signal transmitter DCF-77. Particularly, the portion of the time signal X shown in FIG. 3A includes three complete time frames Y1, Y2, and Y3. The duration of each of the time frames Y1 to Y3 respectively amounts to T=1000 msec or 1 sec. It should be noted that the example illustrated in FIG. 3A is not intended or suitable for representing a particular or special encoding of an actual time information, but instead is presented as a simple generic example of representative features of the signal. Also note, for the sake of clarity, the time scale has been rather drawn out or extended.

The time signal X transmitted by the German time signal transmitter DCF-77 includes two different second markers represented by different amplitude dips for carrying out the binary encoding of the transmitted time information. The first amplitude dip X1 has the duration T1=100 msec, while the second amplitude dip X2 has the duration T2=200 msec. The first dips X1 correspond to the binary “0” (low) while the second dips X2 correspond to the binary “1” (high). In this regard, the binary “1” and “0” respectively correspond to a data bit (see FIG. 3A). FIG. 3A schematically illustrates an idealized time signal with the second markers or amplitude dips X1, X2 embodying or containing respective data bits. While the actual time signal radiated from the time signal transmitter has nearly the idealized form shown in FIG. 3A, various interference signals are superimposed on the essentially ideal time signal in the transmission path between the transmitter and the time signal receiver, and also within the receiver. As a direct result thereof, the time signal as actually received in the time signal receiver no longer has the idealized signal curve as shown in FIG. 3A.

FIGS. 3B and 3C show examples of time signals as actually received by a time signal receiver, having less interference (in FIG. 3B) or more interference (in FIG. 3C) superimposed thereon. The superimposed interference signals can arise from any one or more of various sources, such as: extraneous electromagnetic radiation in the transmission path between the time signal transmitter and the time signal receiver; obstacles such as buildings, bridges or the like in the transmission path; electronic and/or electrical devices such as PCs, monitors, televisions, etc. in the direct proximity of the time signal receiver; electrical and electronic components within the time signal receiver itself; etc. Depending on the type and strength of the interference signals, and the arrangement of the radio-controlled clock receiver, these interference signals may be more or less strongly superimposed on the useful time signal.

Very often, however, the interference signals superimposed on the time signal are relatively small and thus not problematic in the reception, decoding and evaluation of the time information. FIG. 3B schematically illustrates such a case, in which the received time signal comprises relatively small interference components I0. Nonetheless, it is still possible to carry out an unambiguous decoding and thus an unambiguous allocation of bit values to the data bits represented by the amplitude dips X1, X2. For example, for decoding the data bit information in the first time frame Y1, the beginning t1 and the end t2 of the amplitude reduction or dip X1 are determined. Then, from these time points t1, t2, the time duration Δt1=t2−t1 of the amplitude reduction or dip X1 is calculated. This actual measured time duration Δt1 is then compared with the ideal or prescribed first time duration T1 that is defined and known from the pertinent telegram or encoding protocol of the received time signal X. If the actual measured time duration Δt1 corresponds with the ideal prescribed time duration T1, or if the actual time duration Δt1 deviates only insignificantly with respect to an acceptable defined tolerance from the ideal prescribed time duration T1, then the respective data bit allocated to this amplitude dip X1 is valued as an interference-free data bit and is given the bit value associated with the ideal prescribed time duration T1 (i.e. binary “0”).

The process proceeds in a similar manner in the second time frame Y2. Here, the time points t3, t4 of the beginning and the end of the second amplitude dip X2 are determined, and therefrom the actual time duration Δt2=t4−t3 is calculated. In the present example embodiment in FIG. 3B, the thusly calculated actual time duration Δt2 only insignificantly deviates from the ideal prescribed second time duration T2, so that the corresponding data bit of the amplitude dip X2 is valued as an interference-free data bit and the logic bit value associated with the second prescribed time duration T2 (i.e. logic “1”) is allocated thereto. Once again, a similar evaluation is carried out in the third time frame Y3 to determine the interference-free duration of the amplitude dip X1 of this time frame Y3.

In contrast to the signal curve of FIG. 3B, the time signal X in FIG. 3C is so strongly superimposed with interference components (e.g. I1 and I2), that no interference-free data bits are available in the received signal. In other words, none of the data bits in the illustrated portion of the received time signal X in FIG. 3C can be unambiguously decoded and evaluated. In this regard, the attempted evaluation proceeds as follows. For example, in the first time frame Y1, a first time point t5 of the beginning of an amplitude dip X1 is determined. Then, an apparent end of the amplitude dip X1 is detected and the corresponding time point t6 thereof is determined. However, this time point t6 does not represent the actual true end of the intended time signal dip X1, but rather arises from a positive interference component I1, which is superimposed on the time signal X at this time point t6, and thus eradicates and obscures the time signal dip X1 at this time. As far as the receiver is concerned, however, this time point t6 references the end of the apparent received temporary amplitude dip. Thus, the actual measured time duration Δt3=t6−t5 is determined from the time points t5 and t6. Then, this actual time duration Δt3 is compared with the available ideal first and second prescribed time durations T1 and T2. In the present example, the determined actual time duration Δt3 is significantly smaller than the first and second prescribed time durations T1 and T2, even when considering an allowable deviation tolerance. Thus, the conclusion can be reached, that the data bit of this time frame Y1 in FIG. 3C is a data bit that is not-interference-free, i.e. is interference-burdened.

The process again proceeds similarly in connection with the second amplitude dip X2 in the second time frame Y2 in FIG. 3C. Here, the time point t7 corresponding to the beginning of the dip X2, and the time point t8 corresponding to the beginning of an interference I2 which ends the apparent received amplitude dip are respectively detected or determined. From these time points t7, t8, the actual measured time duration Δt4=t8−t7 is calculated or determined, and then compared with the ideal first and second prescribed time durations T1 and T2 of the time signal X. In the present example case, the determined actual time duration Δt4, with consideration of the defined acceptable tolerances, is significantly greater than the ideal first prescribed time duration T1, but significantly smaller than the ideal second prescribed time duration T2. For this reason, the data bit associated with the amplitude dip X2 in the second time frame Y2 is also recognized and identified as a not-interference-free data bit, i.e. an interference-burdened data bit.

In the third time frame, Y3 of the signal shown in FIG. 3C, the time range of the amplitude dip X1 is so strongly superimposed with an interference signal, that absolutely no beginning and no end of a corresponding amplitude dip can be detected. Thus, the associated data bit of this time frame Y3 is immediately recognized and identified as a not-interference-free data bit, i.e. an interference-burdened data bit.

In the case of the time signals shown in FIG. 3B as well in FIG. 3C, the above process can be repeated for plural successive time frames, i.e. plural successive amplitude dips, to provide a respective indication for each time frame or associated data bit, whether the respective data bit is an interference-free data bit that was received without significant interference and could be unambiguously decoded, or an interference-burdened data bit that was received with significant interference and thus could not be unambiguously decoded. Then, in a further step, a determination of the signal quality of the received time signal can be made, based on the number or the ratio of interference-free data bits and of interference-burdened data bits respectively. For example, the ratio of interference-free decoded data bits relative to interference-burdened decoded data bits, for example over the course of a one minute telegram, can be used as a measure or indication of the signal quality. Alternatively, the ratio of interference-free received data bits relative to the total number of received or examined and evaluated data bits, e.g. over the course of a one minute telegram, could be used as an indicator of the signal quality.

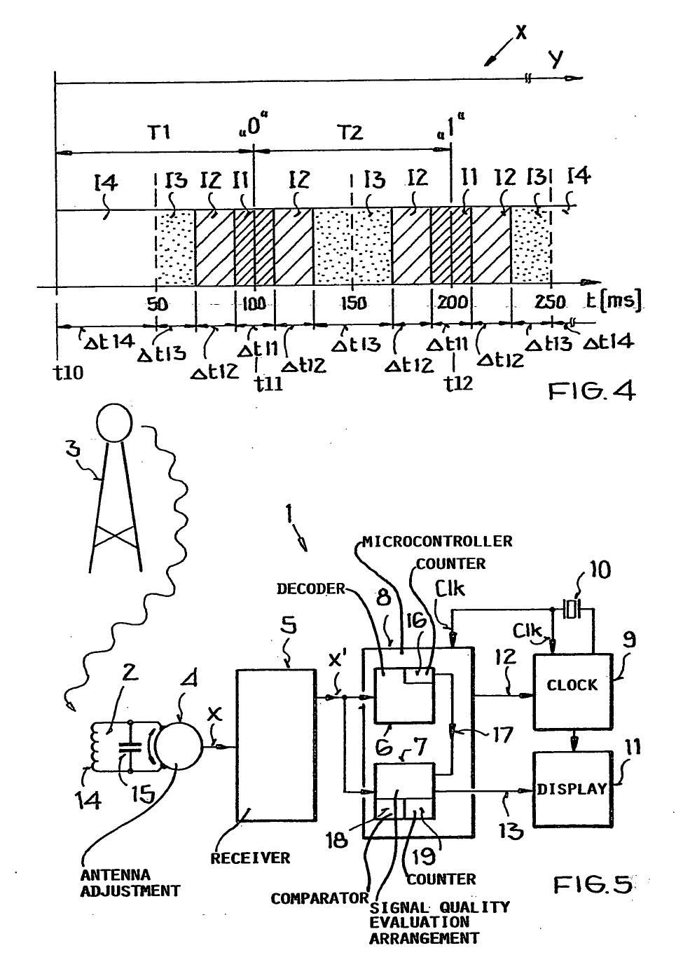

The schematic time diagram of FIG. 4 will serve to explain the inventive determination of the signal quality within a given time frame. As the above discussion, the present example of FIG. 4 also relates to the time signal transmitted by the German time signal transmitter DCF-77.

More particularly, FIG. 4 shows a portion or time-section within any arbitrary time frame Y of the time signal. The second beginning, i.e. the beginning of the respective second of this time frame Y, is referenced with t10=0 msec, i.e. the time point at which the time signal X drops to a low logic signal level. Next, for decoding and thus acquiring the data bit embodied in this time frame Y of the signal X, it is then necessary to determine the time point of the end of the temporary amplitude reduction, i.e. the time point at which the amplitude of the time signal X again returns or rises back to its nominal maximum value. In the ideal case, this renewed amplitude variation back to the high amplitude will occur at either the time point t11=100 msec for a logic zero “0” or at the time point t12=200 msec for a logic one “1”. For this ideal case, it will be recognized that an optimum signal quality exists.

However, in typical operation, the actual received and detected end of the temporary amplitude variation, at which the time signal X again reaches its nominal maximum amplitude value, can more or less sharply deviate from the ideal prescribed time points t11, t12. As described above, a certain degree or range of such deviation is to be expected and is acceptable for an unambiguous and reliable decoding and evaluation of the time information. In order to be able to classify the arising deviations, in order to thereby determine the signal quality, the invention defines, for example, the following intervals I1, I2, I3, and I4, within which the actual renewed amplitude variation at which the amplitude again rises to its nominal high signal level may be detected.

Interval I1: The respective intervals I1 respectively identify ranges of a relatively small deviation about the ideal time points t11, t12, namely a maximum deviation of Δt11=±10 msec about the ideal prescribed time points t11, t12. Thus, with respect to the first prescribed time duration t1=100 msec, or with respect to the difference between the two prescribed time durations T2−T1=100 msec, the deviation Δt11 of the first interval I1 thus amounts to ±10%. This first interval I1 defines the acceptable range of “insignificant” deviation, thus if the determined renewed amplitude variation at which the amplitude rises to its nominal high value lies within this first interval I1, then the corresponding data bit (“0” or “1”) will be reliably and unambiguously recognized. In this case, a counter for the signal quality is incremented by one. Thus, the counter value signal of this counter serves as a measure of the signal quality, because it is incremented for each successive data bit that is recognized as an interference-free unambiguous data bit. Thus, generally a high counter value will indicate a correspondingly high signal quality (in effect summed over a succession of time frames i.e. data bits).

Interval I2: The second intervals I2 respectively designate deviations in the range Δt12=±(10 msec to 30 msec) relative to the time points t11 or t12, namely deviations of maximally ±30%. In other words, the intervals I2 are provided on both sides of the first interval I1 and each have a range of 20 msec from the boundaries of the first interval I1. If the determined renewed amplitude variation is detected within this time interval I2, then the respective logic data bit value (“0” or “1”) will still be recognized, but the signal quality will be identified as not-ideal or lower than the case of falling in the first interval I1. This is achieved in that the counter for the signal quality is not incremented (nor decremented), so that the counter value remains unchanged.

Interval I3: Additionally, third intervals I3 may optionally be provided further outside the range of the second intervals I2. These intervals I3 respectively identify deviations in the range Δt13=±(30 msec to 50 msec) relative to the time points t11, t12, i.e. deviations of maximally ÷50%. If the determined renewed amplitude variation falls in one of these intervals I3, then the counter for the signal quality is decremented, so that the counter value is reduced. This is a signal indicating a very poor signal quality. Nonetheless, it may still be possible, despite the very low signal quality, to recognize the logic bit value of the corresponding data bit (“0” or “1”). The particular methods for decoding and evaluating the logic values of the data bits are not a limitation of the present invention, and can be carried out according to any conventionally known teachings.

Interval I4: Additionally or alternatively to the intervals I3, fourth intervals I4 can be provided. The fourth intervals I4 represent respective deviations of more than Δt14>±50 msec from the time points t11, t12, i.e. deviations of more than ±50%. If the determined renewed amplitude variation falls into one of these intervals I4, then the corresponding logic value of the data bit (“0” or “1”) can no longer be recognized unambiguously.

Thus, the time ranges Δt11, Δt12, Δt13, and Δt14 serve for the classification of deviations of the actual time points of amplitude variations away from the optimal prescribed time points t11, t12, for determining respective corresponding differentiated signal qualities.

The above indicated particular numerical values are merely examples, which do not limit the present invention. Of course, other intervals and other numerical values can alternatively be used. Moreover, a reversed or inverted logic (incrementing instead of decrementing, and vice versa) for the manner of counting by the counter can alternatively be used.

As described above, the inventive first method according to FIG. 3 and the inventive second method of FIG. 4 allow a respective signal quality (among several possible signal quality levels) to be determined for each individual time frame Y, or in the 5 opposite manner, a specific signal quality can be allocated to each time frame Y and therewith to each decoded data bit, whereby the signal quality is specific to this time frame Y or to the associated data bit. Furthermore, the second method according to FIG. 4 additionally allows an overall or ongoing accumulated signal quality to be determined and indicated, over the course of several successive time frames. This is achieved in a very simple manner through an incrementing/decrementing counter, of which the counter value represents a present signal quality on an ongoing basis. Thus, in addition to the determination of the signal quality of each individual time frame Y, thereby an overall or running signal quality of plural successive time frames Y is determined, in that the counter is correspondingly incremented or decremented or held at the same value depending on the determined quality of each time frame, i.e. the respective recognized interval I1 to I4 into which the determined amplitude variation time point falls. Then, the absolute counter value signal is a measure or indication of the overall signal quality of the preceding already-evaluated time frames Y.

FIG. 5 schematically shows a simplified block circuit diagram of a circuit arrangement according to the invention for a radio-controlled clock for carrying out the inventive method. The radio-controlled clock 1 comprises one or more antennas 2 for receiving the time signals X transmitted by the time signal transmitter 3. A receiver circuit 5 for receiving the time signals X transmitted by the transmitter 3 and taken-up by the antenna 2 is connected after or downstream from the antenna 2. The receiver circuit 5 typically comprises one more filters, for example a bandpass filter, a rectifier circuit, and an amplifier circuit for respectively filtering, rectifying and amplifying the received time signal X to produce the corresponding filtered, rectified and amplified time signal X′ at an output. The construction and the functioning of such a receiver circuit 5 is generally known in many different configurations and embodiments, for example from the above mentioned prior art documents, so that the details thereof need not be described here.

The circuit arrangement of the radio-controlled clock 1 further comprises a decoding arrangement 6 that is connected to the output of the receiver circuit 5 and configured and adapted to decode the filtered, rectified and amplified time signal X′ so as to acquire therefrom the data bits and thus the time information. The decoding arrangement 6 can be a component of the receiver circuit 5, or it can be a separate component included in the clock circuit 1. The general construction and operation of such a clock time signal decoding arrangement can be according to any conventionally known teachings.

For determining the signal quality of the received signal, the clock circuit 1 further comprises a signal quality evaluating arrangement 7, arranged after or downstream from the receiver circuit 5 as well as the decoding arrangement 6. The signal quality evaluating arrangement 7 carries out one of the embodiments of the method according to the invention, and preferably the method described in connection with FIG. 4, so as to acquire a respective signal quality from a respective decoded data bit, whereby this signal quality is specifically allocated to this data bit.

Additionally or alternatively, the signal quality evaluating arrangement 7 can be designed, configured and adapted to determine whether an interference-free or an interference-burdened data bit is present, for example by carrying out the inventive method described in connection with FIG. 3. Moreover, the signal quality evaluating arrangement 7 also determines and provides a signal quality value 13 as a measure of the respective determined signal quality.

In the present example embodiment, both the decoding arrangement 6 as well as the signal quality evaluating arrangement 7 are respective components of a program-controlled arrangement 8. The program-controlled arrangement 8 may typically be provided in the form of a microcontroller, which may, for example, be embodied as a four-bit microcontroller in the case of a radio-controlled clock. This microcontroller 8 is designed, configured, adapted and programmed, to receive the data bits produced by the receiver circuit 5 and/or the decoding arrangement 6, and from these data bits to calculate an exact clock time and an exact date based on the time and date information conveyed by the decoded data bits. Then, the microcontroller 8 produces a clock time and date signal 12 from the thusly calculated clock time and date, in any conventionally known manner.

The radio-controlled clock circuit 1 further comprises a local electronic clock 9, of which the displayed clock time is locally controlled by a quartz clock oscillator 10. The electronic clock 9 is connected with a display 11 or other indicator, by means of which the clock time is indicated to a user of the clock. The local electronic clock 9 also receives the time and date signal 12, and in response thereto, the clock 9 corrects or updates the local displayed time and date as necessary. Additionally, the indicator or display 11 also displays the signal quality value 13 (or a corresponding numerical, graphical, iconic or other visual indication) provided by the signal quality evaluating arrangement 7. Thus, on the display 11, the user of the clock can see the current prevailing signal quality of the received time signal, and can take corrective steps (e.g. moving the clock or reorienting the antenna) if necessary to achieve a better signal quality.

In the present example embodiment, the antenna 2 is embodied as a coil 14 with a ferrite core, to which a capacitive element 15, e.g. a capacitance or capacitor 15, is connected in parallel. The antenna 2 is further preferably and advantageously provided with an adjusting arrangement 4 (e.g. a manual rotation dial mechanism or the like), by which the orientation or reception direction of the antenna 2 can be adjusted in a suitable manner. Thus, using the adjusting arrangement 4, such as a manual antenna rotating dial, the receiving antenna 2 can be oriented in the particular direction that achieves the optimum signal quality of the received time signal, e.g. as indicated on the display 11 by the signal quality value 13.

Although the invention has been described and illustrated above in connection with preferred example embodiments thereof, the invention is not limited to these disclosed embodiments, but rather is modifiable to cover a great variety and number of different embodiments. For example, the invention is not limited to the particular numerical values or ranges disclosed herein as examples. To the contrary, the scope of the invention also covers variations or changes of numerical values and ranges as would be understood by a person of ordinary skill in the art upon considering the present disclosure.

In the above described example embodiments, the time encoding was realized by temporary dips or reductions of the signal amplitude of the carrier signal at the respective beginning of respective time frames. It should be understood that the encoding could alternatively be realized by temporary increases or any other variation of the signal amplitude of the carrier signal in the respective time frames. Also, other types of signal modulation could alternatively be used.

While the above discussion has especially related to a radio-controlled clock receiving the time signal via a wireless radio transmission through an antenna, the present invention also relates to a method and clock apparatus receiving a time signal via a hard-wired transmission. For example, systems including several clocks that are to be synchronized with one another and that are connected to each other by a time signal wire for this purpose, can also be embodied according to the present invention, and are covered within the scope of the appended claims. Such clocks may generally be regarded as remote-controlled clocks, but are also to be understood within the term radio-controlled clocks.

The illustrated and explained example embodiment of a receiver circuit is merely one possible example of a concrete circuit for embodying an inventive receiver circuit and radio-controlled clock. This example embodiment can readily be varied by exchanging individual or simple circuit components or entire functional blocks or units, as would be understood by a person of ordinary skill in the art upon considering this disclosure.

In the preceding example embodiments, a signal quality was respectively determined. The signal quality can also refer to or encompass the reception quality, namely the quality of the received time signal. Thus, a possibly existing interference influence on the transmitted time signal, which interference influence arises during the reception, is also taken into account.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of processing a transmitted time signal, comprising the steps:
a) receiving a time signal that has been transmitted from a time signal transmitter, wherein said time signal comprises a succession of time frames and encodes time information bit-wise in successive data bits, with at least a respective one of said data bits provided in each one of said time frames;
b) evaluating a respective signal quality of said time signal respectively for at least one of said data bits in each one of said time frames; and
c) based on said evaluating, further determining and allocating respective signal quality values individually to respective ones of said data bits among respective ones of said time frames.

2. The method according to claim 1, further comprising decoding respective logic values of at least those of said data bits to which said signal quality values above an acceptable quality threshold have been allocated.

3. The method according to claim 1, further comprising visually displaying a signal quality indicator that is dependent on and indicative of said signal quality values allocated to said data bits among said time frames.

4. The method according to claim 1, further comprising indicating or outputting said signal quality value respectively for each one of said time frames.

5. The method according to claim 1, further comprising determining an overall signal quality as an average of said signal quality values allocated to a plurality of said time frames.

6. The method according to claim 1, wherein said data bits encoding said time information are represented respectively by temporary variations of an amplitude of said time signal, a first logic value is assigned respectively to each one of said temporary variations having a first specified duration, and a second logic value different from said first logic value is assigned respectively to each one of said temporary variations having a second specified duration different from said first specified duration.

7. The method according to claim 6, wherein said first logic value is a logic zero and said second logic value is a logic one.

8. The method according to claim 6, wherein said temporary variations are temporary reductions of said amplitude of said time signal.

9. The method according to claim 6, further comprising, before said step b), an additional step of determining and evaluating respective actual durations of said temporary variations.

10. The method according to claim 9, wherein said determining of said actual durations comprises counting timing pulses of a reference timing pulse signal having a defined reference frequency.

11. The method according to claim 9, wherein said determining of said actual durations comprises, respectively for each respective one of said temporary variations, detecting an apparent beginning of said respective temporary variation at a first time point, detecting an apparent end of said respective temporary variation at a second time point, and determining a respective one of said actual durations for said respective temporary variation as a difference between said second time point and said first time point.

12. The method according to claim 9, wherein said evaluating of said actual durations comprises comparing each respective one of said actual durations to said first specified duration and said second specified duration.

13. The method according to claim 12, wherein said evaluating of said signal quality comprises, based on results of said comparing, determining respective deviations of said actual durations from said specified durations, and said determining and allocating of said signal quality values is carried out dependent on said deviations so that relatively higher values of said signal quality values are associated with lower values of said deviations and relatively lower values of said signal quality values are associated with higher values of said deviations.

14. The method according to claim 6, wherein said evaluating of said signal quality comprises, respectively for said data bits in said time frames, determining an actual duration of said respective temporary variation and a deviation of said actual duration from at least one of said first and second specified durations, and wherein said determining and allocating of said respective signal quality values comprises determining and allocating a relatively higher signal quality value in response to a lower value of said deviation and a relatively lower signal quality value in response to a higher value of said deviation.

15. The method according to claim 14, further comprising defining a first interval corresponding to a first range of said deviations about said one of said first and, second specified durations, and defining a second interval corresponding to at least one second range of said deviations having absolute values greater than and falling outside of said first range, and wherein said determining and allocating of said respective signal quality values comprises allocating a first Signal quality value to each one of said data bits of which an associated one of said deviations falls into said first interval, and allocating a second signal quality value lower than said first signal quality value to each one of said data bits of which an associated one of said deviations falls into said second interval.

16. The method according to claim 15, further comprising defining a third interval corresponding to at least one third range of said deviations having absolute values greater than and falling outside of said first range and said at least one second range, and wherein said determining and allocating of said respective signal quality values further comprises allocating a third signal quality value lower than said second signal quality value to each one of said data bits of which an associated one of said deviations falls into said third interval.

17. The method according to claim 16, further comprising defining a fourth interval corresponding to at least one fourth range of said deviations having absolute values greater than and falling outside of at least one of said at least one second range and said at least one third range, and wherein said allocating of said respective signal quality values does not apply to said data bits of which an associated one of said deviations falls into said fourth interval in that no signal quality value is allocated to said data bits of which said associated one of said deviations falls into said fourth interval.

18. The method according to claim 17, further comprising decoding respective logic values of said data bits to which said first signal quality value or said second signal quality value has been allocated, and not decoding respective logic values of said data bits to which said third signal quality value or no signal quality value has been allocated.

19. The method according to claim 15, wherein said allocating of said respective signal quality values comprises respectively incrementing, decrementing or not-changing a counter value for each one of said signal quality values by respective positive, negative or zero counter value adjustments, wherein different ones of said counter value adjustments are used in response to and dependent on different ones of said signal quality values.

20. The method according to claim 14, further comprising measuring a field strength of said time signal being received, and wherein said determining of said respective signal quality values additionally comprises determining a respective one of said signal quality values further in response to and dependent on said field strength value respectively pertaining for a respective one of said data bits to which said respective signal quality value is to be allocated.

21. The method according to claim 6, wherein said first and second specified durations are respectively selected from the group consisting of durations of 100 msec, 200 msec, 300 msec, 400 msec, 500 msec, and 800 msec.

22. The method according to claim 1, further comprising scanning stored parameter sets that respectively identify different encoding protocols by which said time information may be encoded in said time signal so as to identify a respective one of said encoding protocols and a corresponding particular time signal transmitter by which said time signal was transmitted, if said step c) was unable to determine or allocate a respective one of said signal quality values to one of said data bits in at least one of said time frames or if said respective signal quality value determined and allocated to one of said data bits in at least one of said time frames is below a predetermined minimum quality threshold.

23. A method of processing a transmitted time signal, comprising the steps:
a) receiving a time signal that has been transmitted from a time signal transmitter, wherein said time signal comprises a succession of time frames and encodes time information bit-wise in successive data bits, with at least a respective one of said data bits provided in each one of said time frames;
b) respectively determining whether each one of a plurality of said data bits is an interference-free data bit that was received without significant interference in said step a) or an interference-burdened data bit that was received with significant interference in said step a); and
c) determining a signal quality of said time signal received in said step a) from and dependent on a first number of said interference-free data bits determined in said step b) and a second number of said interference-burdened data bits determined in said step b).

24. The method according to claim 23, further comprising, before said step b), decoding said time signal received in said step a) so as to acquire said data bits from said time signal.

25. The method according to claim 23,
wherein said data bits encoding said time information are represented respectively by temporary variations of an amplitude of said time signal, a first logic value is assigned respectively to each one of said temporary variations having a first specified duration, and a second logic value different from said first logic value is assigned respectively to each one of said temporary variations having a second specified duration different from said first specified duration;
further comprising, before said step b), an additional step of determining respective actual durations of said temporary variations; and
wherein said determining in said step b) determines that a respective one of said data bits is one said interference-burdened data bit if said actual duration of said temporary variation representing said respective data bit deviates from said first specified duration and from said second specified duration by at least a prescribed deviation value.

26. The method according to claim 23,
wherein said data bits encoding said time information are represented respectively by temporary variations of an amplitude of said time signal, a first logic value is assigned respectively to each one of said temporary variations having a first specified duration, and a second logic value different from said first logic value is assigned respectively to each one of said temporary variations having a second specified duration different from said first specified duration;
further comprising, before said step b), an additional step of determining respective actual durations of said temporary variations; and
wherein said determining in said step b) determines that a respective one of said data bits is one said interference-free data bit if said actual duration of said temporary variation representing said respective data bit corresponds to one of said first and second specified durations or deviates from one of said first and second specified durations by no more than a prescribed acceptable deviation of not more than ±10%.

27. The method according to claim 26, wherein said prescribed acceptable deviation is not more than ±5%.

28. The method according to claim 23, wherein said steps b) and c) are carried out for one minute, said plurality of said data bits are said data bits included in a one-minute telegram of said time signal, and said signal quality determined in said step c) is a signal quality of said time signal during said one-minute telegram.

29. The method according to claim 28, wherein said steps b) and c) are repeated successively for successive one-minute telegrams of said time signal to determine a successive plurality of said signal qualities respectively pertaining to said successive one-minute telegrams, and further comprising determining an overall signal quality by averaging said plurality of said signal qualities.

30. The method according to claim 23, wherein said determining in said step c) comprises determining said signal quality from a first ratio of said first number relative to said second number or from a second ratio of said first number relative to a sum of said first number plus said second number.

31. A circuit arrangement for receiving and acquiring time information from a time signal that is transmitted by a time signal transmitter and that has said time information encoded in successive data bits in successive time frames therein, said circuit arrangement comprising:
a receiver adapted to receive said time signal;
a decoder connected to an output of said receiver and adapted to decode said time signal to acquire and decode said data bits therefrom; and
a signal quality evaluation arrangement connected to said receiver and to said decoder and adapted to determine and allocate a respective signal quality of said time signal received by said receiver respectively for each data bit decoded by said decoder per each one of said time frames.

32. The circuit arrangement according to claim 31, further comprising a reference timing signal generator adapted to generate a reference timing signal of reference timing pulses having a predetermined reference frequency, wherein said decoder comprises a first counter connected to said reference timing signal generator and adapted to count said reference timing pulses and to produce a corresponding first counter value signal that is provided to said signal quality evaluation arrangement as a measure of an actual duration of a respective signal variation of said time signal representing a respective one of said data bits.

33. The circuit arrangement according to claim 32, wherein said signal quality evaluation arrangement comprises a comparator adapted to compare said actual duration with at least one of first and second prescribed durations to determine any deviation therebetween.

34. The circuit arrangement according to claim 33, wherein said signal quality evaluation arrangement further comprises a second counter connected to said comparator and adapted to provide a second counter value that depends on and is indicative of said signal quality allocated to a respective one of said data bits within a respective one of said time frames.

35. The circuit arrangement according to claim 31, wherein said signal quality evaluation arrangement is a circuit component incorporated in a hard-wired FPGA-circuit or a hard-wired PLD-circuit.

36. The circuit arrangement according to claim 31, further comprising a display connected to said signal quality evaluation arrangement and adapted to display a signal quality indication that is dependent on and indicative of said signal quality.

37. The circuit arrangement according to claim 31, further comprising a re-orientable antenna adapted to receive said time signal and selectively oriented so as to maximize said signal quality.
